(19) United States
(12) Patent Application Publication
(10) Pub. No.: US 2012/0018107 A1
(43) Pub. Date: Jan. 26, 2012

(54) PORTABLE VENTILATION CURTAIN FRAME

(75) Inventor: Rodney HOWERY, Cedar Bluff, VA (US)

(73) Assignee: HEINTZMANN CORPORATION, Cedar Bluff, VA (US)

(21) Appl. No.: 13/186,893

(22) Filed: Jul. 20, 2011

Related U.S. Application Data
(60) Provisional application No. 61/366,031, filed on Jul. 20, 2010.

(51) Int. Cl. A47H 23/00; B23P 17/00; A47H 1/022

(52) U.S. Cl. 160/330; 211/124; 29/525.01

(57) ABSTRACT

A support for an air ventilation control curtain includes a foldable support rod comprising a plurality of rigid hollow rod sections that are movable with respect to each other, a coupling for joining an axial end of one of the rod sections to an axial end of another one of the rod sections, an attachment device slidably mounted on the support rod so as to be movable along a length of the support rod, the attachment device adapted for engaging with a roof plate of a mine roof, and a curtain hanger disposed on the support rod for hanging an air ventilation control curtain from the support rod.

### CROSS-REFERENCE TO RELATED APPLICATIONS

This application claims priority from U.S. Provisional Patent Application No. 61/366,031 the disclosure of which is incorporated herein by reference in its entirety.

### BACKGROUND

1. Field

The present invention relates generally to mine ventilation control, and more specifically, is directed to a portable frame or support device, and method of use thereof, for attaching a ventilation curtain to a mine for providing ventilation diversion. The portable support device provides an ability to erect the ventilation diversion curtains efficiently and effectively without requiring the use of additional tools.

2. Related Art

Currently, ventilation controls are manually attached to the roof and ribs of a mine by use of hammer and nails, or other similar labor-intensive means. For instance, a ventilation control, which may include a ventilation curtain, is suspended from a mine roof using tools, cumbersome wood support frames, and other tedious methods. This manual procedure is labor intensive and time consuming.

### SUMMARY

An effective ventilation system is one of the most essential and important elements in underground mining. Having the ability to efficiently construct or repair the ventilation system is vital to providing an overall effective ventilation system to improve safety for mine workers.

An embodiment of the support disclosed herein vastly improves the conventional manner for using ventilation controls by improving upon the cumbersome task of installing ventilation controls by providing a portable device that easily attaches a ventilation curtain to the roof and ribs of a mine without requiring tools or complicated installation procedures. This eliminates not only the need for tools, but also wood frames, standing supports and other extraneous and heavy materials, and improves the handling and overall use of ventilation technology in a mining environment, particularly in difficult environmental conditions.

The present invention provides a support, and a manner of use thereof, that expedites installation of ventilation controls.

A support for an air ventilation control curtain, consistent with the present invention, comprises a foldable support rod comprising a plurality of rigid hollow rod sections that are movable with respect to each other, a coupler for provisionally joining an axial end of one of the rod sections to an axial end of another one of the rod sections, an attachment device slidably mounted on the support rod so as to be movable along a length of the support rod, the attachment device adapted for engaging with a roof plate of a mine roof, and a curtain hanger disposed on the support rod for hanging an air ventilation control curtain from the support rod.

Thus, the support rod is portable since it is foldable, yet easily assembled by the use of couplers which temporarily join the axial ends of the rod sections together when the rod is needed. Since the attachment devices are slidable along the support rod, it is easy to quickly align the attachment devices under the pre-existing roof plates for engagement thereo.

The coupler has a sleeve structure having an inner diameter which is larger than an outer diameter of the axial ends of the rod sections, so that the axial ends of the rod sections are removable inserted into the coupler in order to be joined together in axial alignment.

The curtain hanger is mounted on the attachment device, so as to be slidable along the length of the support rod.

Thus, the curtain hangers can be spread apart along the length of the support rod in such a manner to provide adequate support to the curtain.

The attachment device has an inner diameter which is larger than an outer diameter of the coupler, so that the attachment device is slidably movable over the coupler disposed on the support rod.

Thus, the attachment device can be placed anywhere along the length of the support rod, since the coupler does not prevent its movement.

In addition, a tensioned wire may be threaded through all of the hollow rigid rod sections, having one end secured to a first end of the support rod and another end secured to a second end of the support rod, so as to connect the rod sections to each other when the rod sections are not joined together by the coupler.

Thus, the multiple rod sections are kept together for easy transport even though they are in a folded condition. Moreover, they are tensioned so as to easily move away from and toward each other, particularly during the process of folding and unfolding the support rod.

In addition, an air ventilation control device consistent with the invention, includes a foldable support rod having a plurality of rigid hollow rod sections that are movable with respect to each other, a coupler for joining an axial end of one of the rod sections to an axial end of another one of the rod sections, an attachment device slidably mounted on the support rod so as to be movable along a length of the support rod, the attachment device adapted for engaging with a roof plate of a mine roof, an air ventilation control curtain, and a curtain hanger disposed on the support rod for hanging the air ventilation control curtain from the support rod.

A method of assembling a support for an air ventilation control curtain, includes the steps of unfolding a support rod having a plurality of rigid hollow rod sections that are movable with respect to each other from a folded condition to an unfolded condition, axially aligning and coupling the rod sections together in series, sliding a plurality of attachment devices along the support rod so that the attachments devices are respectively aligned with and disposed under a plurality of roof plates on a mine roof, securing the attachment devices to the roof plates, and hanging an air ventilation control curtain from the support rod.

### BRIEF DESCRIPTION OF THE DRAWINGS

Aspects of the exemplary embodiment will be more apparent by reference to the drawings provided herewith, which include multiple illustrations of the invention.

FIG. 1 illustrates a perspective view of a support rod according to an exemplary embodiment of the invention;

FIG. 2A illustrates an initial step for hanging an assembled rod with respect to a mine entry before it is attached to roof plates or a ventilation curtain;

FIG. 2B illustrates an intermediate step for hanging an assembled rod from a mine roof with a curtain attached thereto;

FIG. 2C illustrates the rod in its fully assembled position against a mine roof with a curtain attached thereto;

FIG. 3 is an enlarged view of an attachment device that is slidable on a rod section;

FIG. 4A is an enlarged view of an attachment device engaged with a roof plate, having a curtain hanger formed thereon;

FIG. 4B is an enlarged view of another attachment device engaged with the roof plate;

FIG. 5 is an enlarged view of a curtain hanger mounted directly to the rod;

FIG. 6 illustrates the rod in its folded condition;

FIG. 7 illustrates a slider having a curtain hanger without means for hanging from the roof plate; and

FIG. 8 provides an enlarged view of the attachment device on the rod.

### DETAILED DESCRIPTION

An exemplary embodiment will now be described in conjunction with the appended figures.

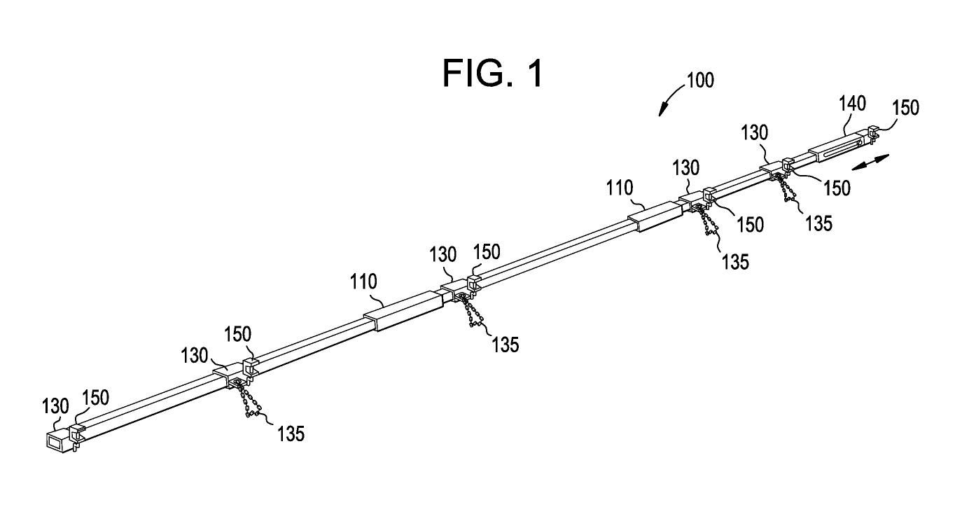

An exemplary embodiment utilizes a portable ventilation frame as shown in FIG. 1, which includes a ventilation control support rod or beam, with slidable components provided thereon, for hanging a ventilation control curtain therefrom. Such a portable ventilation frame or rod can be used as a permanent or temporary structure, since it is easily transported to a desired location, erected and removed, without tools or complicated steps.

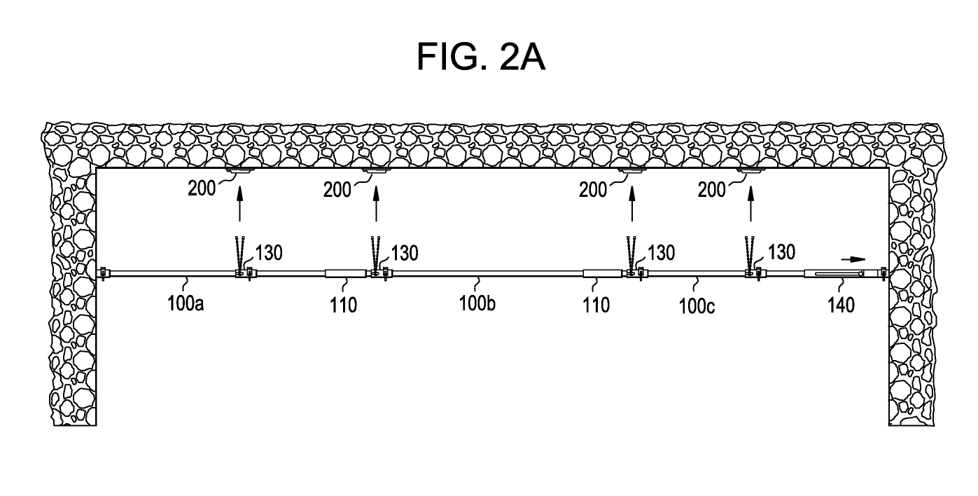

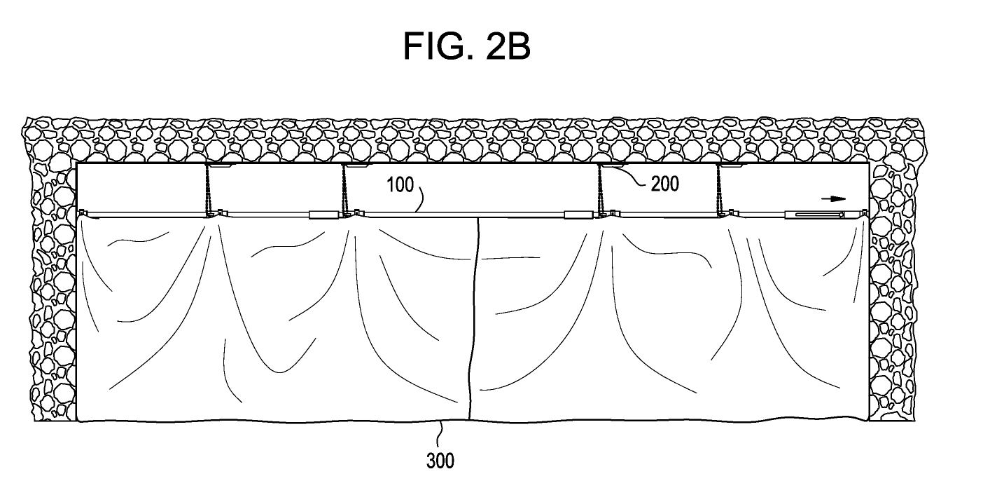

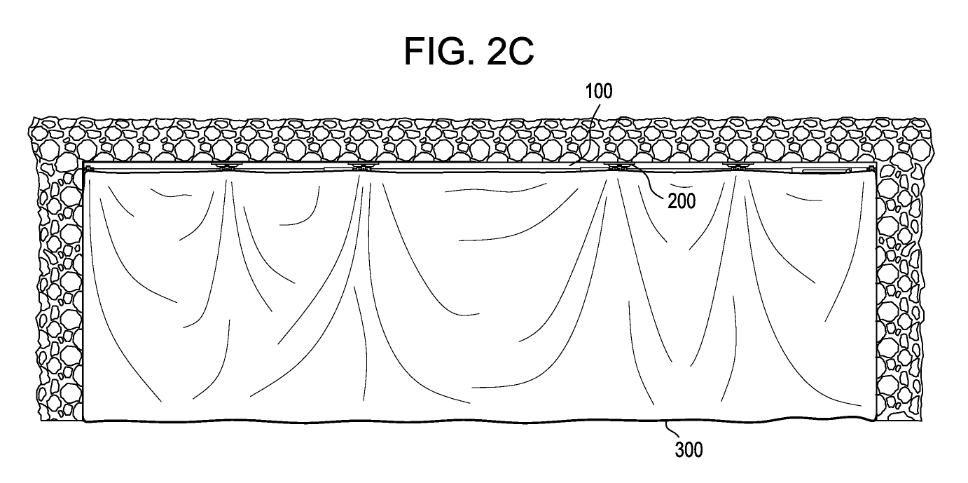

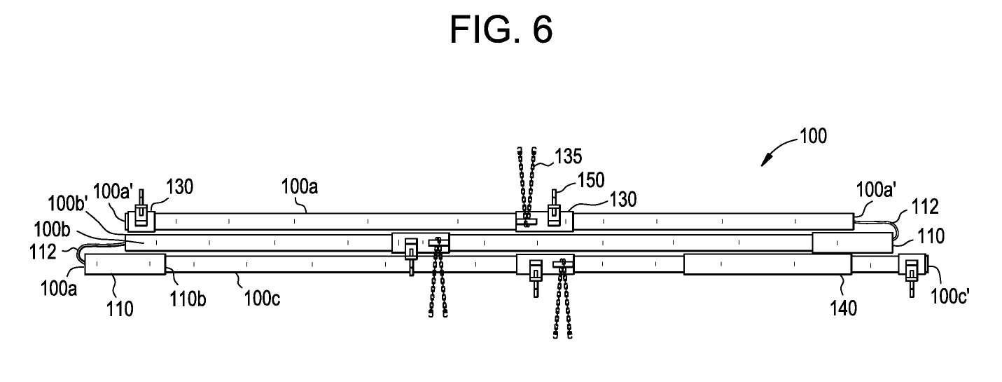

The rod or beam (hereinafter a “rod”, shown in its unfolded and extended form in FIG. 1, and in its folded form in FIG. 6) is easily hung from pre-existing roof plates mounted on a mine roof, with the use of attachment devices that are slidably moveable along the length of the rod to align with and directly under, the roof plates. When the rod is hung from the mine roof (see FIGS. 2A-2C), a ventilation control curtain can be easily attached to the rod without the use of tools or external equipment that is not intrinsic to the rod support. That is, all the components required for hanging the ventilation curtain are self-stored on the rod itself. Additional framing, bolts, clips, or other extraneous materials are not required to ensure an effective ventilation diversion.

The ventilation control system according to an exemplary embodiment includes a support rod 100 adapted for use with a ventilation curtain 300 and mine roof plates 200.

The support rod 100, or beam, may be composed of a variety of materials, such as steel, alloy, graphite, Kevlar and other material composites. The thickness, length and height dimensions of the support rod 100 vary depending on the type of ventilation control required and the specifications of the mine, particularly the mining entry. The support rod 100 retracts manually or mechanically and/or folds for easy handling and portability. The rod 100 is illustrated in FIG. 1 in its unfolded condition and in FIG. 6 in its folded condition. The support rod 100 is configured so as to be easily suspended by roof plates or other similar means.

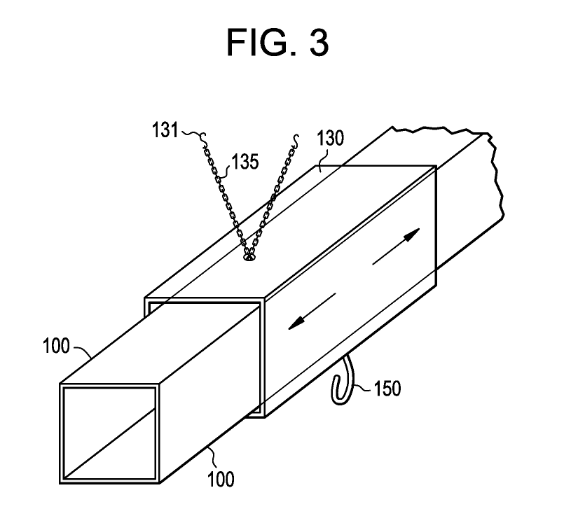

The support rod 100, for example, may be composed of longitudinally extending hollow square tubing (FIG. 3). The tubing may be 1.5 inch square, for instance, and its thickness and material based on the weight of the curtain to be hung from the rod. Alternatively, the rod may be rectangular, elliptical, or circular tubing, sleeving, or any desired shape and dimension to meet the needs of the user and environment, as long as it is capable of supporting the ventilation curtain, and reaching across the mine entry.

The support rod 100 may be divided into multiple rod sections which are foldable together so that the rod sections lay in parallel for storage when in a folded condition. The number of sections varies depending on the overall length of the support rod 100. A minimum number of sections is not required; however, enabling the rod to fold into multiple sections improves the portability of the device.

The required overall length of the support rod 100 depends on the width of the mine in which the rod is to be used. The width of a mine typically ranges from 16 to 22 feet; however, the exemplary embodiment is not limited to this range.

As an example, an 18 foot support rod may include three 6-foot sections. Since the sections are foldable onto each other, the rod is very portable in its folded state despite its 18 foot assembled length in its unfolded state.

In order to facilitate the easy folding and unfolding capabilities of the support rod 100, the hollow interiors of the support rod sections may include a wire 112, rope or cable with one or more springs or other elastic means threaded through the multiple sections, so as to keep the folded sections connected even when disassembled and in their folded condition. The support rod 100 may also include tensioners which may work in conjunction with the rope or cable to maintain tension between the rod sections during assembly and disassembly.

The rod is illustrated in its folded condition in FIG. 6, wherein the support rod 100 comprises a plurality of rigid hollow sections 100a, 100b, 100c . . . each rod section 100 having two axial ends 100a′, 100b′, 100c′ . . . wherein adjacent ends of adjacent sections are at least provisionally joined together by a coupler 110, except for the first and second outer distal ends of the rod, i.e., one end of each of the first and last sections of the rod 100 which are set substantially flush against, or proximal to, a mine rib when installed. In the embodiment shown in FIG. 6, this is shown as one of the ends 100a′ of rod section 100a and one of the ends 100c′ of the rod section 100c, which do not join with the middle rod section 100b.

The flexible wire 112, rope, cable or similar element sequentially passes through the interior of all of the rigid hollow rod sections 100, serving to keep the sections 100a, 100b, 100c attached even when in a folded condition, and to tension the sections during assembly and disassembly between the folded and unfolded conditions. For example, the spring-loaded wire 112 may have first and second ends corresponding to and anchored to the first and second outer distal ends of the rod 100, i.e., two axial outer ends of the assembled rod 100, so as to be continuously threaded through all of the rod sections in series, so that the rod sections can be pulled apart from each other in their axial directions and folded using the wire as an elbow, to facilitate assembly and breakdown of the rod unit.

As the folded rod 100 is unfolded from the folded state in FIG. 6 to the unfolded state in FIG. 1, the couplers 110 which are provided on certain ends 100a′, 100b′, 100c′ . . . of at least some of the rod sections 100a, 100b, 100c . . . adjoin adjacent rod sections together in a stable and secure condition, thereby functioning as a joint which keeps the sections 100a, 100b, 100c together for as long as needed, whether temporary or as part of permanent installation. For example, in the rod 100 shown in FIG. 1, three rod sections are provided, and two couplers are provided, since the couplers only need to be provided at the junction of the rod sections.

Thus, the couplers 110 splice two adjacent sections 100a, 100b, 100c of the rod 100 together at their axial ends 100a′, 100b′, 100c′, so that they are stably held in axial alignment with each other so as to have a single common longitudinal axis. Likewise, the support rod 100 can be easily disassembled by pulling the sections apart, against the tension of the wire 112, so at least one of the ends 100a′, 100b′, 100c′ of the sections pull out of each of the couplers 110, thereby enabling the rod 100 to fold so that the sections 100a, 100b, 100c are disposed in parallel to each other for easy storage and portability of the entire support device. Thus, the rod sections 100a, 100b, 100c are attached in such a manner that they can be easily coupled in series and de-coupled in parallel to each other without the use of any tools.

The couplers 110 have a sleeve structure, with two opposing open axial ends 110a, 100b for accepting ends 100a′, 100b′, 100c′ of adjacent sections 100a, 100b, 100c therein. The couplers 110 can be provided so as to have the same overall cross-sectional shape as the rod section fitted therein, but with a slight clearance to allow the ends 100a′, 100b′, 100c′ of the rod sections 100a, 100b, 100c to insert into the hollow interior of the open axial ends 110a, 110b of the coupler 110. For instance, a square shaped cross-section support rod may include square cross-sectioned couplings that are dimensioned large enough to be fitted over the periphery of the axial ends 100a′, 100b′, 100c′ of the rod sections 100a, 100b, 100c, so as to allow axial ends of adjacent rod sections to fit into the coupler 110 in a sleeve like fashion thereby attaching one section to another section within the coupler. Similarly, if the rod has a circular cross-section, the coupling may have a circular cross-section. With any shape, the inside diameter or dimension of the coupling is large enough to accommodate the outside diameter or dimension of the rod.

Alternatively, the outer dimensions of the coupler 110 may be dimensioned smaller than the inner dimensions of the ends 100a′, 100b′, 100c′, so that the coupler 110 fits inside the ends of the rod sections 100a, 100b, 100c, thereby holding two adjacent end sections in axial alignment.

Each of the couplings 110 may be immovably anchored on one of the ends 100a′, 100b′, 100c′ of the sections, respectively, so as to extend axially outward from the one of the ends, when the rod is in the folded condition. That is, each coupling may be immovably anchored (or permanently attached) to the end of one section so as to be fixed onto the end of the one section when the rod is in a folded condition, while being capable of accepting the end of another section in a temporary state in the unfolded, assembled condition. With this structure, the couplings are held securely in position for easier assembly and disassembly.

Still further, the couplers 110 may be slidably anchored to the end of one section, respectively, so as to slide into position (so as to cover axial ends of two sections that are being coupled together) when two sections are brought together into axial alignment in the unfolded condition. When the two adjacent sections are to be separated, the couplers 110 are slidably retracted onto the end of the section so as to allow the separation of the two rod sections. With either structure, the couplers 110 are self-stored on the section 100a, 100b, 100c.

In the exemplary embodiment of FIG. 6, two couplers are provided: one coupler 110 is provided on each of rod sections 110b and 110c. In particular, a first coupler 110 is provided on axial end 110b′ for joining with axial end 110a′ of rod section 110a, and a second coupler 110 is provided on axial end 110c′ for joining with axial end 110b′ of rod section 110b. In the folded condition, the end 110a is detached from the axial end 100b′, but the end 110b is anchored to the end 100c′. A similar configuration is provided for the other coupler 110, wherein one end is detached from axial end 100a′ but the other end of the coupler 110 is anchored to the axial end 100b′.

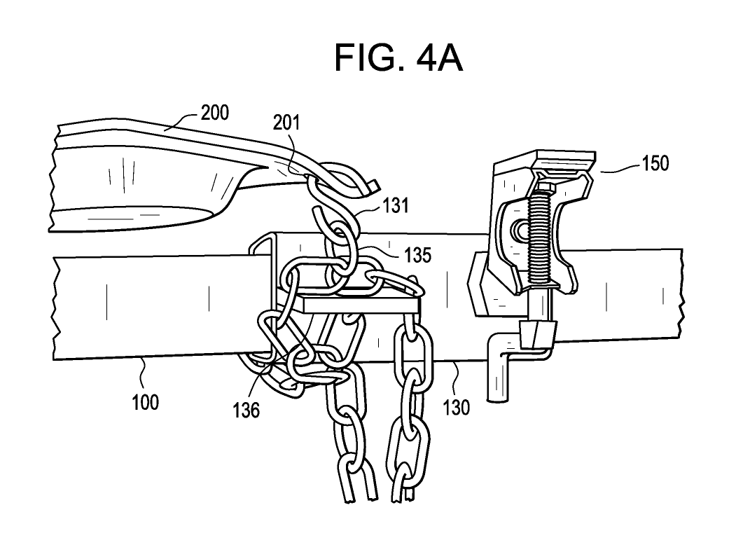

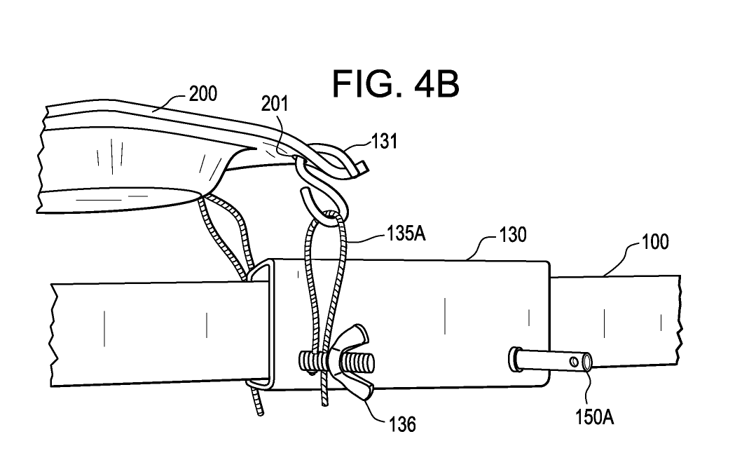

Next, a description of attachment devices which are slidably mounted on the support rod are described in detail. Specifically, attachment devices 130 are sliders which slide freely along the length of the entire support rod 100 or within each rod section 100a, 100b, 100c. The attachment device 130 may be formed in a sleeve structure, so as to fit over an exterior perimeter portion of the rod 100 (FIG. 3). Each attachment device 130 is slidable along an axial length of one of the sections, and includes means for hanging 135, such as a chain, wire, rope, cable, etc., which extend from the sliding attachment device 130 so as to engage and secure with a roof plate 200 on a mine roof without requiring any tools. For instance, referring to FIGS. 4A and 4B, an S-hook 131 can hook onto an opening 201 or hook on another portion of the roof plate 200. The S-hook 131 is attached to means for hanging, such as chain 135 or cable 135A, which is attached to the sliding attachment device 130 at attachment portion 136 or 136A, (either at a top surface of the attachment device 130 as illustrated in FIG. 3, or on a side surface of the attachment device 130 as in FIGS. 4A and 4B). The chain 135, cable 135A, or similar hanging means can be a cord or any comparable mechanism. If the chain 135 or cable 135A is adjustable in length, the top surface of the support rod 100 can be easily raised up to be brought into close proximity to the mine roof (see FIG. 2C), thereby reducing any gap between the curtain and the mine roof, which thereby enhances air diversion and the overall effectiveness of the ventilation curtain without complicated tools. For example, in the embodiment of FIG. 4B, the cord 135A can easily be adjusted in length, by having one end of the cord attached in a fixed position to a screw, and another end of the cord slidable through a hole in the screw, with a wingnut or similar mechanism for tightening the cord at a desired length so that the cord is pressed into position and not able to move during use. The chain 135 in FIG. 4A may function similarly, wherein excess chain material is simply pulled through a hole on the attachment portion 136 and wrapped around the attachment portion until stably held in place at a desired length. Other structural equivalents may be used which provide means for adjustably hanging the rod from the roof plate at a desired height.

Since the sliding attachment devices 130 are axially slidable along the longitudinal length of the rod 100, they can be aligned with and positioned directly under the roof plates 200 easily. That is, it is easy to align the attachment devices 130 with the roof plates 200 which are pre-affixed to the mine roof. A locking mechanism can be provided on each attachment device 130 for temporarily locking the sliding attachment device 130 in position on the rod 100 once it has been properly positioned with respect to a respective roof plate 200. The locking mechanism can utilize a wingnut and bolt, or other similar means which is easily locked and unlocked without tools.

The attachment device 130 may have the same cross-section shape as the support rod 100 and coupler 110, so as to have a sleeve-like structure which essentially envelopes or surrounds the rod 100. For instance, a circular cross-sectioned rod can be used with a circular cross-sectioned attachment device, wherein the inner diameter of the attachment device is large enough to accommodate the outer diameter of the rod, thereby allowing the slider to freely move along the length of the rod section.

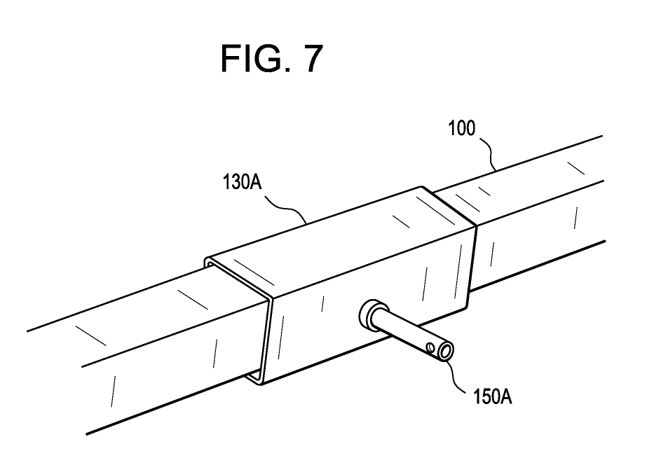

There is no limit to the number of attachment devices (sliders) per rod or per rod section. However, a minimum number of attachment devices should be provided to ensure adequate support of a ventilation curtain to be hung from the rod. In particular, at least two sliders would be needed to secure the rod in two positions on the mine roof to keep it stably hung from the mine roof. Also, a slider 130A may be provided without any attachment device thereon, for attaching to the roof plate. That is, the slider 130A may include a curtain hanger 150A, but not a means for hanging the rod from a roof plate (see FIG. 7).

Moreover, the inner diameters of the attachment devices may be large enough to allow the attachment devices to slide freely over the couplers after the rod sections are joined together with the couplers in axial alignment with each other, particularly if more or less attachment devices are needed on one rod section than another rod section. In other words, the inner diameter of the attachment device may be larger than the outer diameter of the coupler, in order to allow the attachment device enough clearance to axially slide over the coupler disposed on the rod thereby providing greater flexibility in placement of the attachment device with respect to the pre-mounted roof mount plates 200.

If the mine entry is wider than the total assembled length of the support rod 100, or extra length is needed for the support rod for any other reason, a slider extension 140 can be provided on at least one axial end of the support rod 100. That is, the slider extension 140 may be provided at the distal end of the end section 100c of the support rod 100 (as shown in FIG. 1), either added on-site or pre-mounted on the support rod 100 before reaching the mine site. The slider extension 140 can be longer than the attachment devices 130, thereby providing additional length to the support rod 100 since it can be slid to extend axially outward from the end of the rod 100. In other words, the slider extension 140 retracts or extends axially outward from the end of the rod 100, thereby imparting additional flexibility with respect to the overall length of the assembled rod. The slider extension 140 may have a sleeve-like structure similar to the attachment devices 130, so that it is pulled from the end of the rod to extend from the end of the rod 100 the desired distance and then locked in place with a locking mechanism to keep it positioned relative to the rest of the support rod 100. It can have a curtain hanger (control clip) attached thereto.

The slider extension 140 can have the same cross-sectional shape as the rod 100, but with a slightly larger hollow interior (inner dimension or inner diameter) than the exterior dimension of the rod 100, so that the support rod 100 fits axially inside the slider extension 140. This structural configuration allows the slider extension 140 to easily slide from the distal end of the end section of the rod 100, thereby adding a desired length to the rod 100, such as a few inches to several feet. It is also possible to fashion the slider extension 140 to be stored inside the end section of the rod 100, i.e., inside the hollow rigid structure of the rod 100, wherein its outer diameter is less than the inner diameter of the rod 100, so that the slider extension 140 is inserted inside the rod 100, and simply pulled to extend outward as needed. Essentially, the combination of the slider extension 140 with the end of the rod section 100c forms a telescoping structure, so that the slider 140 telescopes with respect to the rod section 100c, providing easy and efficient capabilities for the user to expand or retract the size of the assembled rod as needed on-site.

Since the slider extension 140 has curtain hangers/control clips, it possible to hang ventilation curtains 300 over extended widths of a mine entry, even if the roof plates 200 are not adequately provided over such extended widths.

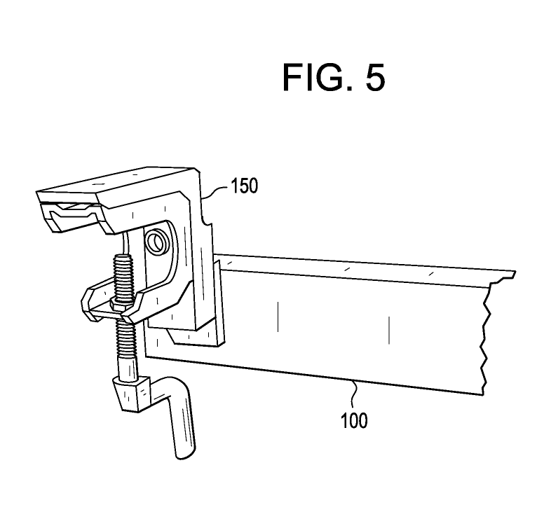

Curtain hangers, or control clips, 150 or 150A are used to attach, suspend and/or hang ventilation control curtains 300 from the support rod 100. The curtain hangers 150 are mounted to the support rod 100 directly (FIG. 5) and/or to the attachment devices 130 (FIG. 4A, 4B) and/or slider extension 140 (FIG. 1) and/or slider 130A alone (FIG. 7). The hangers 150, 150A secure the curtain 300 to the rod 100. For instance, a rotatable screw, spring-loaded dowel, spring-loaded clip, etc. can be used to pinch a top edge of the curtain 300 for attachment to the support rod 100, attachment device 130, slider extension 140 and/or slider 130A. Cumbersome tools are not necessary and thus, the curtain can be easily hung from the support rod.

For instance, the curtain hanger 150A may be provided as a dowel or peg, which protrudes from a front side of the slider 130A or attachment device 130. The dowel 150A is sturdy enough so that the curtain 300 can be held flush against a protruding end of the dowel so that the dowel pierces the curtain. A hammer may be used to facilitate this piercing action. Additionally, a hole may be provided which is aligned perpendicularly to the longitudinal axis of the dowel 150A, which can accept a carter pin or similar device to keep the curtain between the hole and the surface of the slider 130A, 130, thereby preventing the curtain from falling off the dowel 150A.

The roof plates 200 may be pre-mounted to the roof structure. They provide a means for attaching the rod 100 to the roof. Roof plates 200 may be bolted to the mine roof or mounted to the roof by other means. The S-hooks 131, or similar mechanisms, then quickly and easily hook onto the roof plate 200 to suspend the rod 100 from the mine roof, when the air diversion is needed without requiring the use of any tools or particular skills.

The support rod 100, couplings 110, attachment devices 130, 130A and slider extensions 140 and sliders 130A may be formed of any material that is strong enough to withstand the forces typically experienced in a ventilation structure device. For example, metal, Kevlar, or other material capable of supporting the weight of the rod 100 and the curtain 300 from the roof plates 200 and mine roof may be used. However, the use of light weight material for the frame structure enhances the portability aspect of the device, and thus, most preferable especially for support rods that are particularly long and requiring more than a few rod sections.

With the present invention, it is easy to erect a ventilation diversion in a mine setting, without the use of tools, complex procedures, or special skills. The straightforward process for erecting the ventilation diversion includes, inter alia, unfolding the rod 100, axially aligning the rod sections 100a, 100b, 100c into place with the couplers 110, sliding the attachment devices 130 under the roof plates 200, securing the attachment devices 130 to the roof plates 200, and then securing the curtain 300 to the curtain clips 150. Additional steps may include sliding a slider extension 140 outward from a distal end of the end section 100c of the support rod 100, to provide additional length to the support rod 100 if needed. Other additional steps may include locking the couplers, locking the attachment devices and/or locking the slider extension with locking mechanisms to the support rod for additional stability. Still further, the support rod may be brought closer to the mine roof and/or roof supports by shortening the length of a chain, cord or wires 135, 135A that hang the attachment devices 130 and/or sliders 130A from the roof plates 200.

With the present invention, it is easy to disassemble a ventilation diversion in a mine setting, without the use of tools, complex procedures or specialized skills. The straightforward process for disassembling the ventilation diversion includes, inter alia, removing or disengaging the curtain 300 from the curtain clips 150, unlocking any locking mechanisms holding the sliders, couplings or slider extensions, retracting any extended slider extensions 140, separating or disengaging the attachment devices 130 from the roof plates 200, sliding the axial ends of the rod sections 100a, 100b, 100c from the couplers 110 and folding the rod sections 100a, 100b, 100c to lay in parallel with each other.

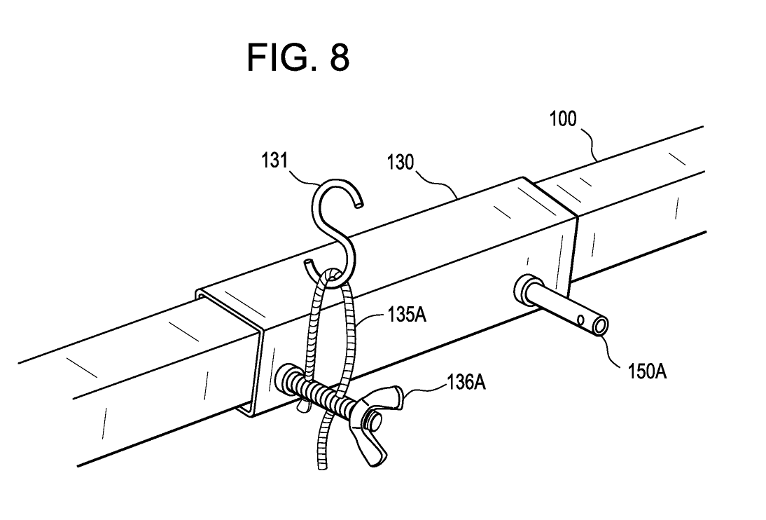

FIG. 8 provides another view of an embodiment of the invention. As shown, the attachment device 130 includes the cord 135A and dowel 150A structures. The dowel 150A may be combined with the chain 135 shown in FIG. 4A, and the cord 135A may be combined with the clip 150, as any of the combinations of the sliders, curtain hangers, extensions, and attachment devices can be used in combination and interchangeably with each other.

The exemplary embodiments described herein expedite overall installation of a ventilation system, so that reliable air ventilation can be achieved more quickly than previously possible with conventional devices and procedures.

While the present inventive concept has been particularly shown and described with reference to exemplary embodiments thereof, it will be understood by those of ordinary skill in the art that various changes in form and details may be made therein without departing from the spirit and scope of the present inventive concept as defined by the following claims.

What is claimed:

1. A support for an air ventilation control curtain, comprising:
a foldable support rod comprising a plurality of rigid hollow rod sections that are movable with respect to each other;
a coupler for provisionally joining an axial end of one of the rod sections to an axial end of another one of the rod sections;
an attachment device slidably mounted on the support rod so as to be movable along a length of the support rod, the attachment device adapted for engaging with a roof plate of a mine roof; and
a curtain hanger disposed on the support rod for hanging an air ventilation control curtain from the support rod.

2. The support according to claim 1, wherein the coupler has a sleeve structure having an inner diameter which is larger than an outer diameter of the axial ends of the rod sections, so that the axial ends of the rod sections are removable inserted into the coupler in order to be joined together in axial alignment.

3. The support according to claim 1, wherein the curtain hanger is mounted on the attachment device, so as to be slidable along the length of the support rod.

4. The support according to claim 2, wherein the attachment device has an inner diameter which is larger than an outer diameter of the coupler, so that the attachment device is slidably movable over the coupler disposed on the support rod.

5. The support according to claim 1, further comprising a tensioned wire threaded through all of the hollow rigid rod sections, having one end secured to a first end of the support rod and another end secured to a second end of the support rod, so as to connect the rod sections to each other when the rod sections are not joined together by the coupler.

6. An air ventilation control device comprising:
a foldable support rod comprising a plurality of rigid hollow rod sections that are movable with respect to each other;
a coupler for joining an axial end of one of the rod sections to an axial end of another one of the rod sections;
an attachment device slidably mounted on the support rod so as to be movable along a length of the support rod, the attachment device adapted for engaging with a roof plate of a mine roof;
an air ventilation control curtain; and
a curtain hanger disposed on the support rod for hanging the air ventilation control curtain from the support rod.

7. The support according to claim 6, wherein the coupler has a sleeve structure having an inner diameter which is larger than an outer diameter of the axial ends of the rod sections, so that the axial ends of the rod sections are removable inserted into the coupler to be joined together in axial alignment.

8. The support according to claim 6, wherein the curtain hanger is mounted on the attachment device, so as to be slidable along the length of the support rod.

9. The support according to claim 7, wherein the attachment device has an inner diameter which is larger than an outer diameter of the coupler, so that the attachment device is slidably movable over the coupler disposed on the support rod.

10. A method of assembling a support for an air ventilation control curtain, comprising:
unfolding a support rod having a plurality of rigid hollow rod sections that are movable with respect to each other from a folded condition to an unfolded condition;
axially aligning and coupling the rod sections together in series;
sliding a plurality of attachment devices along the support rod so that the attachments devices are respectively aligned with and disposed under a plurality of roof plates on a mine roof;
securing the attachment devices to the roof plates; and
hanging an air ventilation control curtain from the support rod.
